(19) United States
(12) Patent Application Publication
(10) Pub. No.: US 2004/0252972 A1
(43) Pub. Date: Dec. 16, 2004

(54) Video recording device

(76) Inventors: Lifen Yuan, Singapore (SG); Steven Anthony Barron, Carmel, IN (US)

Correspondence Address: THOMSON MULTIMEDIA LICENSING INC, JOSEPH S TRIPOLI, PO BOX 5312, 2 INDEPENDENCE WAY, PRINCETON, NJ, 08543-5312, US

(21) Appl. No.: 10/867,462

(22) Filed: Jun. 14, 2004

(30) Foreign Application Priority Data
Jun. 13, 2003 (EP) 03291418.6
Sep. 1, 2003 (EP) 0329146.2

(51) Int. Cl. H04N 5/93

(52) U.S. Cl. 386/83; 386/61

(57) ABSTRACT

The invention refers to a video recording device, having a timer comprising time input means for receiving a start time. The timer further comprises means for computing an end time based on the start time, start time entering conditions and a predetermined duration.

This application claims the benefit, under 35 U.S.C. § 365 of European Patent Application No. 03291418.6, filed Jun. 13, 2003 and European Patent Application No. 0329146.2, filed Sep. 1, 2003.

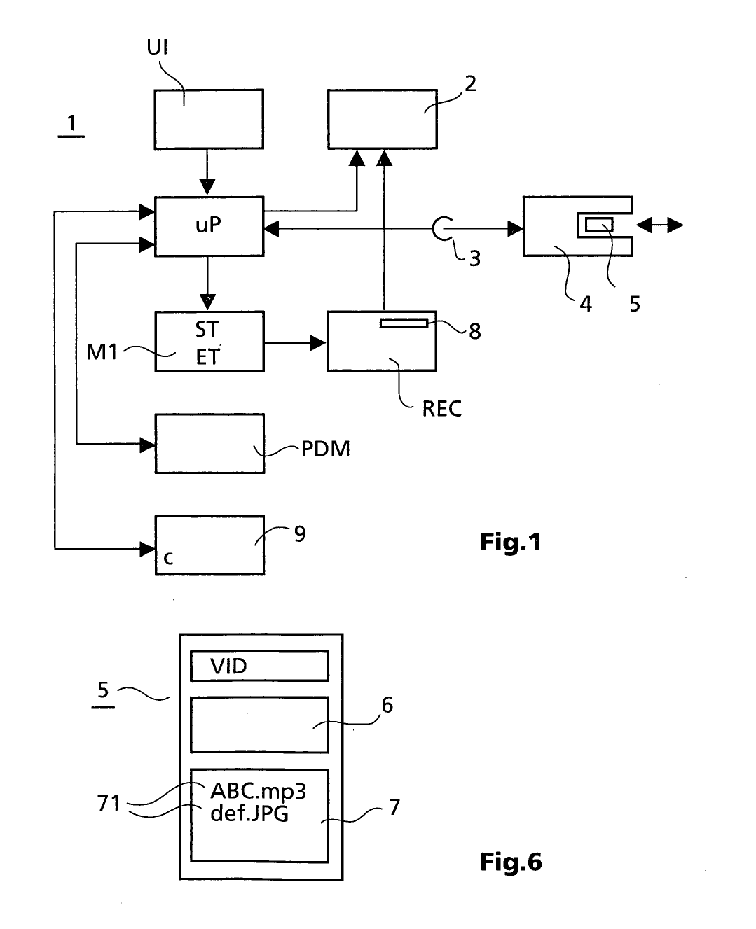

FIG. 1 is a block diagram of a video recording device according to one embodiment of the invention,

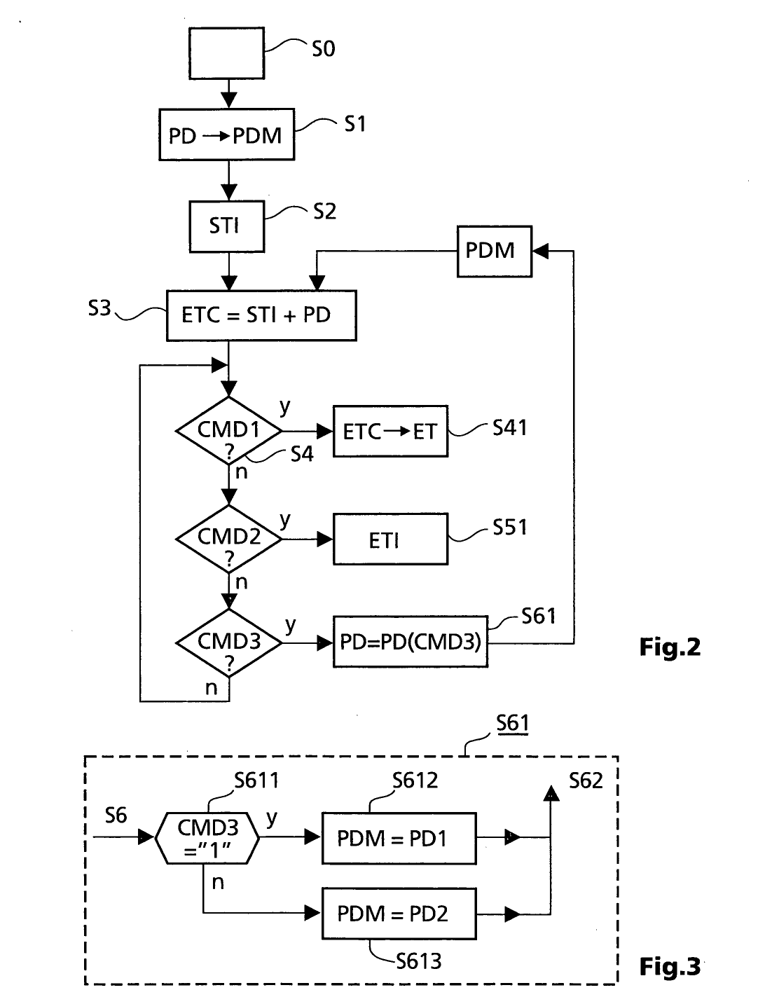

FIG. 2 is a flow chart illustrating a method.

FIG. 3 is a flow chart according to an embodiment of the invention,

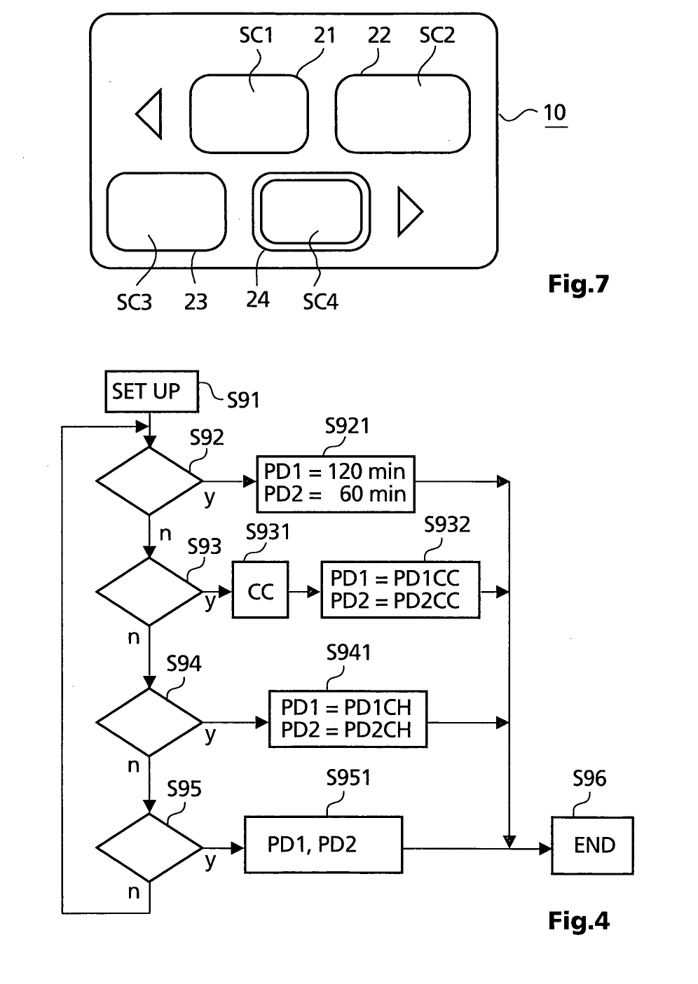

FIG. 4 is a flow chart illustrating steps of a method according to an embodiment of the invention,

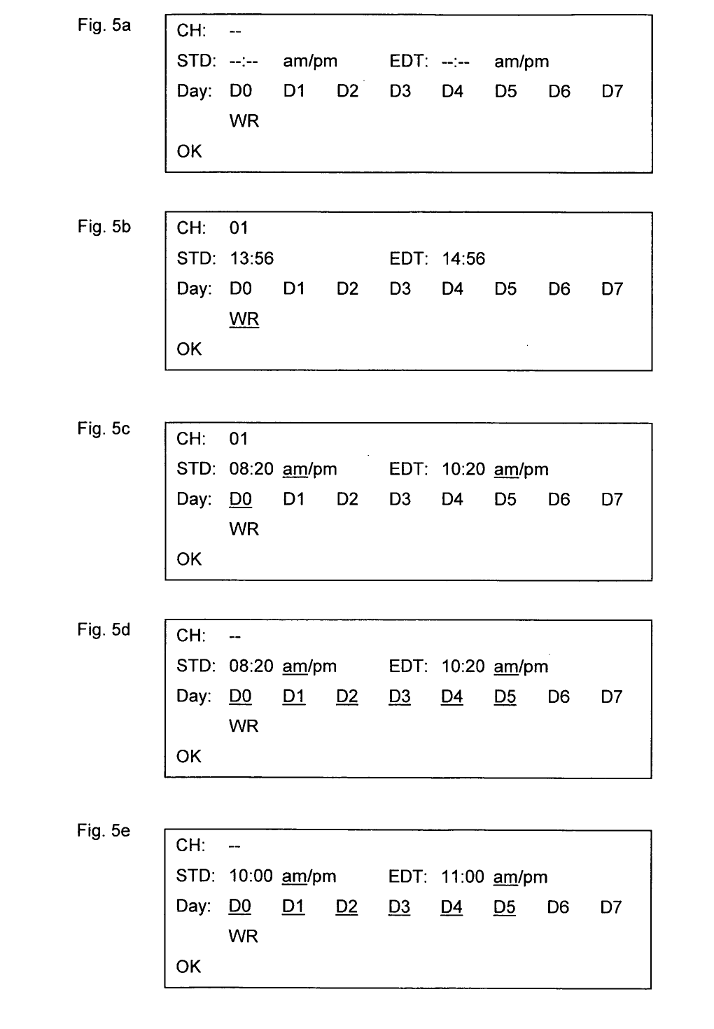

FIG. 5a-5e illustrate displays according to an embodiment of the invention,

FIG. 6 is a block diagram of a removable medium according to one embodiment of the invention,

FIG. 7 illustrates a display according to an embodiment of the invention.

Preferably, a further input command is detected to belong to a second or a third type of commands. A second type command is a command that indicates that the user wants to set the end time manually or at least does not wish the current end time to be changed automatically. In case such second type command is received, no more calculation of the end time is performed. A third type command is a command that indicates that a new calculation of the end time is to be performed. For example, if the input time was changed, a new calculation of end time is performed. These features have the advantage, that the end time is automatically updated where necessary, but that no automatic update occurs in situations where the user most likely will not agree to modifications.

According to the invention, the predetermined duration is changed dependent on whether the user selects a “single event” timer or a “repeated event” timer. This has the advantage to provide the user with an acceptable end time in even more cases, as usually a “single event” timer refers to recording of longer duration, as a movie, while a “repeated event” timer usually refers to several short recordings like soap opera, drama, variety show and the like.

Preferably, the invention provides for setting the predetermined duration, e.g. during a set-up run, to a value most suitable for the user. A country dependent setting requires the user to enter the country where the device is used in and selects the predetermined duration according to a table of countries. This has the advantage that the predetermined duration is set to 60 minutes for countries where sitcoms usually take up to 60 minutes, and to other durations in countries having a different time scheme. Also preferably used is a channel dependent setting. This has the advantage to adapt the predetermined duration to the special time scheme of special channels, like a news channel having a 15 minutes time scheme or a movie channel having a 90 minutes time scheme. The channel dependent predetermined duration may also be dependent, in addition, to the day time or to the day of the week. Some channels have an hourly time scheme in the morning and the afternoon while a different time scheme is used in late afternoon and evening. For example a 45 minutes block followed by a 60 minutes block followed by two 30 minutes blocks followed by a 90 minute block may occur. Preferably, other channels change the time scheme between working days and weekend days. In case that the user prefers a different, unique time scheme, a user selected predetermined duration is provided for.

Preferably, the end time calculation is performed only if there is no other end time indication available. Such end time indication may be derived from an electronic program guide or a video programming system like VPS. Here, too, the user can set his preference regarding program guide derived end time or calculated end time.

The time of an electronic device preferably comprises input means for receiving a start time and further inputs, and means for computing an end time based on the start time, a predetermined duration and start time entering conditions. Start time entering conditions may be the selection of predetermined durations made in a set-up as described above or single event/multiple event timing conditions and the like. A video recorder equipped with such timer provides the user a very comfortable timer programming with a very low number of figures to key in.

Further advantages can be taken from the description of preferred embodiments. Of course, different combinations of features than those described are also in the scope of the invention. The figures show:

FIG. 1 shows a schematic view of video recording device 1 according to an embodiment of the invention. A recording and playback section REC outputs a playback signal to a display 2. The display 2 is also provided for displaying a timer menu as provided by a microprocessor uP. The microprocessor uP receives commands from a user interface UI and transfers start time ST and end time ET to a memory M1. In dependency on the times ST, ET set in memory M1 the recording and playback section REC starts and ends recording if timer mode is selected. The microprocessor is also connected to a predetermined duration memory PDM for receiving a predetermined duration PD and for calculating an end time ETC therefrom and from an input start time STI. A disk as recording medium 8 is shown inserted into recording and playback section REC. In an embodiment of the invention medium 8 is a removable disk, for example, DVD or a hard disk. The device 1 is also provided with a further memory 9. The device 1 has also a link 3 through which an external removable media device 4 for removable media 5 is connectable to and disconnectable from the device 1.

FIG. 3 shows a timer programming method for updating step S61 according to one embodiment of the invention. In step S611 it is checked whether the third type command indicates a single event recording. If this is the case, the predetermined duration memory PDM is updated with a first predetermined duration value PD1 in step S612. If in step S611 a repeated event recording is detected, the predetermined duration memory PDM is updated in step S613 with a different duration, the second predetermined duration PD2.

FIG. 4 shows a set-up procedure regarding timer programming according to one embodiment of the invention. After set-up is started in step S91 a user's request is detected. In step S92 it is checked whether standard conditions are requested. In this case the first predetermined duration PD1 is set to 120 minutes and the second predetermined duration PD2 is set to 60 minutes in step S921. If in step S93 it is detected that country dependent determination is selected, the country information is determined in step S931. In one embodiment, this is accomplished by direct user input. Alternatively this is accomplished by checking an already existing country information. Following, in step S932 first and second predetermined duration PD1, PD2 are set to country dependent values PD1CC, PD2CC. In an embodiment of the invention, a table indicating appropriate values for each country CC is available. In step S94 it is checked whether channel dependent determination is selected. In this case predetermined durations PD1 and PD2 are set to channel dependent values PD1CH, PD2CH in step S941. In one embodiment, the latter are preferably taken from a respective table. In step S95 it is checked whether the user wants to determine the durations himself and the predetermined durations PD1, PD2 are received in step S951 from the user. In step S96 the predetermined durations PD1, PD2 are stored to the predetermined duration memory PDM.

FIGS. 5a to 5e show different displays during timer programming according to one embodiment of the invention. The selected channel is indicated by CH, start time and end time are displayed as STD and ETD, the day of the timer programming is indicated by D0 to D7, wherein D0 is today, D1 is the following day, D2 the second following day and so on. A weekly repeat is indicated by WR. A confirmation command is indicated by an ok button OK. For countries where the am/pm time standard is used, such indications are given. A timer recording that shall be repeated from the next day until the 4^{th} next day, the day indicators D1, D2, D3 D4 are to be selected by the user.

It is now described to increase the stop time automatically to be some fixed duration later than the start time when setting up a timer. A problem occurs when the user is setting up a new timer or is modifying an existing timer in Timer Setup Screen. That is, all possible entries CH, STD, ETD must be entered, otherwise an error message will appear. According to the described embodiment by default the stop time ETD is set to one hour later than the start time STD with the input start time STI being the start time. If no start time STI is input, the current time is taken as start time STI. With this new proposal, the user is provided with a more convenient way to setup a timer with the duration PD the same as the fixed one by entering the start time only, such as 1 hour. For example -when user has entered the start time completely, i.e. all four digits of STD the end time ETD is updated automatically by advancing it one hour from the start time, since most of the time the user would setup timers with one hour duration. So user need not to enter an end time ETI if that is the record duration he wants. He can also change the end time ETD by entering another four digits.

In one embodiment of the invention, the duration is pre-set in the systems. It will be set to values other than the one hour if it is more desirable, e.g. based on program duration statistics. The regular programs as drama or variety show are commonly one hour or half an hour long at least in US and Singapore.

When a new timer is set up, the Timer Setup Screen, as shown in FIG. 5b, is perforated with default values. The current channel, here channel 01 is used, the Current System Time, e.g. 13:56, is used for the default Start Time STD, and Current

Time plus one hour as the default Stop Time ETD, here 14:56. And with the method according to the invention the device provides additional functions. These bring convenience while setting up new timers. In one embodiment the End Time ETC is set to a pre-determined duration. The predetermined duration PD is later than the actual Start Time STD, automatically after the user completes the four digits entry of Start Time STI. In this case the user needs not set the End Time ET. He has an option to rely upon the automatically set End Time ETC. Of course it is still possible to set a preferred end time, ET, thus overriding the calculated end time. Dependent on the timer frequency, the pre-fixed amount of time PD is, for example, 120 minutes for ONCE timers, as this event is most likely to be a movie. PD is, for example 60 minutes for timers with other frequencies. This duration is suitable for sitcoms, variety shows and the like. In one embodiment, this step is applicable to new timers, and not to modified timers. Further, normally the End Time is set automatically only once. In one embodiment a user does not navigate from STD to other buttons, but only highlights on Start Time Button STD. The user enters complete Start Time STI repeatedly or toggles the am/pm repeatedly, if available. In that case, the End Time ETD would update automatically according to the Start Time STD and the Frequency.

Here are some examples for of various embodiments of the invention. FIG. 5c-e show a first example. By default, the Frequency is ONCE, i.e. single event recording. Hence when the user opens up a new timer, the default End Time ETD would be PD=120 minutes later than the Start Time STD. Here, the current time is 08:20, thus STD=08:20 and ETD=10:20. The channel is channel 01. Now the user moves down to the Day Button, and changes the Frequency from D0 (single day) to D0-D5 i.e. Mon-Fri if the current day is Monday, see FIG. 5d. No change on Start time STD or Stop time ETD is done at this stage. Now the user enters 10:00 as Start Time, and the Stop Time updates to 11:00 automatically, as PD2=60 minutes is used for repeated event, see FIG. 5e. Without leaving the Start Time Button, the user now toggles am to pm, the Stop Time updates to 11:00 pm also (not shown), as the start time field has not been left. Further, without leaving the Start Time Button, the user changes the Start Time to 02:00am, and the stop time automatically updates to 03:00am (not shown).

Suppose the user navigates away from the Start Time Button, e.g. to change the frequency, and comes back to set the Start Time STD. Or, suppose a user goes to the Stop Time ETD and changes the Stop Time ETD and comes back to set the Start Time STD. Under both conditions, the end time ETD is not updated automatically again, according to one embodiment. The described navigation commands belong to a second type of commands that indicates that no further automatic update is desired. However, a user can enter their preferred ones.

FIG. 5c-e show a second example: By default, the Frequency is ONCE, i.e. single event recording. Hence when the user opens up a new timer, the default End Time ETD would be PD=120 minutes later than the Start Time STD. Here, the current time is 08:20, thus STD=08:20 and ETD=10:20. The channel is channel 01. Now the user moves down to the Day Button, and changes the Frequency from DO (single day) to D0-D5 i.e. Mon-Fri, see FIG. 5d. No change on Start time STD or Stop time ETD is done at this stage. Now the user enters 10:00 as Start Time, and the Stop Time updates to 11:00 automatically, as PD2=60 minutes is used for repeated event, see FIG. 5e. Suppose, now the user navigates away from the Start Time Button. When he comes back to the Start Time Button again, the End Time does not update automatically but stays as in FIG. 5e. I.e., the navigation command is taken as an indication that no further update is desired.

FIG. 6 shows in diagrammatic form the content of a removable medium 5. A first memory area contains the volume identification VID, a second memory area contains the file structure 6 and a third memory area is the data area 7 where several files 71 are stored.

The inventive method is more flexible than known solutions. For example, the fixed duration, feature of an embodiment of the invention is added on the start time to compute the end time. The fixed duration feature according to the invention can precise. The invention includes a variety of possible values based on the frequency varying countries and channels. Prior art solutions only advance a fixed duration based on the current clock time upon the first attempt. This is frequently not the real start and stop the user wants. Therefore, subsequent adjusting of the start timer is usually required. In this case it loses the flexibility. Hence, this hence does not really solve the problem of setting up a timer manually, which takes longer time to set up a time.

One inventive way of setting up the end time is by advancing a various fixed duration from user desired start time. This approach offers the flexibility and convenience of setting up timers manually. Every entry of the timer has its default value for ease of setting up the timer. However, every entry also has the flexibility of inputting manually and directly. This approach accommodates inputting the digits directly, which is sometimes more convenient than using “+”/“−” keys as used in prior art.

1. A method for programming a timer comprising the steps of:
receiving an input start time;
calculating an end time based upon said input start time and a predetermined duration;
receiving an input command;
taking said calculated end time as end time if said input command is an end type command.

2. The method according to claim 1 including the steps of:
determining a command type; and,
if said input command belongs to a second type command, not performing calculation of end time
returning to the calculating step using starting values updated in accordance with said input command if said input command belongs to a third type command.

3. The method according to claim 1, including the steps of:
receiving an input command; setting predetermined duration to a first duration in case an input command “single event recording” is set; and,
setting predetermined duration to a second duration in case an input command “repeated event recording” is set.

4. The method according to claim 3, wherein said first and second duration are selected from the group comprising: country dependent predetermined duration; channel dependent predetermined duration; user selected predetermined duration, and day time or week day dependent predetermined duration.

5. The method according to claim 2, wherein said predetermined duration is a first duration in case an input command “single event recording” is set, and a second duration in case an input command “repeated event recording” is set.

6. The method according to claim 5, wherein said first and second duration are are selected from the group comprising: country dependent predetermined duration, channel dependent predetermined duration; user selected predetermined duration, and day time or week day dependent predetermined duration.

7. An electronic timer comprising:
time input means for receiving a start time means for computing an end time based on at least one of:
start time, start time entering conditions and predetermined duration.

8. The timer according to claim 7, wherein said predetermined duration is a first duration in case an input command “single event recording” is set, and a second duration in case an input command “repeated event recording” is set.

9. The timer according to claim 8, wherein said first and second duration are selected from the group comprising country dependent predetermined duration, channel dependent predetermined duration, user selected predetermined duration, day time or week day dependent predetermined duration.

10. The timer according to claim 7 including a video recorder.

11. The method of claim 1, wherein the steps of the method are carried out by a video recorder.
